(19) United States
(12) Patent Application Publication
(10) Pub. No.: US 2006/0249299 A1
(43) Pub. Date: Nov. 9, 2006

(54) Electrical cable having a surface with reduced coefficient of friction

(76) Inventors: Randy D. Kummer, Villa Rica, GA (US); David Reece, Carrollton, GA (US); Mark D. Dixon, Carrollton, GA (US); John R. Carlson, Newnan, GA (US); Hai Lam, Douglasville, GA (US); Philip Sasse, Douglasville, GA (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/135,807

(22) Filed: May 24, 2005

Related U.S. Application Data
(63) Continuation-in-part of application No. 11/120,487, filed on May 3, 2005.
(60) Provisional application No. 60/587,584.

(51) Int. Cl. H01B 7/00

(52) U.S. Cl. 174/120 R

(57) ABSTRACT

The present invention includes a cable having reduced surface friction and the method of manufacture thereof including steps in which a conductor wire is coated with a first plastic material and with a mixture of a second plastic material and lubricating material and the coated conductor wire cooled. The cable includes at least one conductor core and at least two coatings of plastic material and incorporates a lubricating material in and/or on the outer layer of plastic material. The equipment for the manufacturing of the electrical cable includes a reel for supplying a conductor wire to an extruding head, which is connected to tanks containing plastic material and lubricating material for coating the conducting wire, and a reel for taking up the cable.

This application is a continuation-in-part of U.S. patent application Ser. No. 11/120,487, filed May 3, 2005 which claims the benefit of priority of U.S. Provisional Patent Application No. 60/587,584 filed Jul. 13, 2004, and U.S. patent application Ser. No. 10/952,294, filed Sep. 28, 2004 which are herein incorporated by reference.

The present invention relates to an electrical cable and to a method of and equipment for reducing its coefficient of friction.

### BACKGROUND OF THE INVENTION

Electrical cables which include at least one conductor core and at least one coating are well known.

Such cables present the disadvantage that their exterior surface has a high coefficient of friction, so that they are awkward to fit in internal sections of walls and ceilings or conduits, since when they come into contact with the surfaces they become stuck or difficult to pull, etc.

In order to overcome said difficulty, alternative materials such as vaselines and the like have been used to coat the exterior surface of the cable, thereby reducing the coefficient of friction.

In a complementary manner, guides of small diameter are sometimes used, one end of which is inserted through the cavity through which the cable has to pass and the other is attached to the end of the cable which must be inserted into the cavity. Thus, once the guide has emerged at the desired place it is pulled until the end of the cable appears again after having passed through the entire section.

In numerous fields of application, and in particular telecommunications, electric or fiber optic cables are inserted into ducts. There is therefore a need to minimize the coefficient of friction between cables and the inside walls of ducts.

In one solution, the core of the cable passes via a first extruder which applies a conventional sheath thereto i.e., a jacket and/or insulation, often made of polyethylene. The sheathed core then passes through a second extruder which applies a lubricant layer thereto, such as an alloy of silicone resin and polyethylene. The cable lubricated in that way then passes in conventional manner through a cooling vessel.

A second solution provides for an extruder to cover the core of a cable with a sheath. At the outlet from that extruder there is disposed a coating chamber for applying granules of material to the still-hot sheath, which granules are designed to become detached when the cable is inserted in a duct. Finally, the coated cable passes through a cooling vessel.

In both of these two prior solutions, it is necessary to interpose additional equipment between the extruder and the cooling vessel. That gives rise to a major alteration of the manufacturing line.

In addition, the equipment for depositing the lubricant must be very close to the sheath extrusion head since otherwise it is not possible to control the thickness of the sheath properly. In any event, the additional equipment occupies non-negligible space and such an arrangement is not favorable for control over the dimensions of the sheath.

Whatever the prior art method used, the manufacture and/or installation of said cables involves a considerable loss of time and an economic cost, since alternative materials are required.

### OBJECTS AND SUMMARY OF THE INVENTION

The present invention thus seeks to provide a method for making a cable having a surface with reduced coefficient of friction that does not significantly alter the geometrical characteristics of the cable and the cable so produced.

The invention thus provides a method for incorporating a lubricant in the sheath of a cable, the sheath being made by means of an extruder and optionally followed by a cooling vessel.

In one embodiment of the present invention, the lubricant material is mixed with the sheath material prior to either material being heated.

In another embodiment of the invention, the lubricant material is heated and mixed with the sheath material prior to the sheath material being heated.

In a further embodiment of the invention, the lubricant material is mixed with the sheath material after both materials have been heated.

In yet another embodiment of the invention, the non-heated lubricant material is mixed with heated sheath material.

As used herein the term sheath means a jacket and/or insulation applied to the core of a cable.

### DESCRIPTION OF THE INVENTION

With the method and cable of the invention said disadvantages can be solved, while providing other advantages which will be described below.

The method for the manufacture of electrical cables is characterized in that it includes a step in which a lubricating material is mixed with the sheath material and this mixture is applied to the core of the cable.

A cable with low coefficient of friction is achieved thereby, so that subsequent installation of the same is considerably simplified, since it slides over the surfaces with which it comes into contact.

The step of mixing the lubricating material and the sheath material may be carried out with the lubricating material heated or not and the sheath material heated or not.

The sheath material normally is introduced in pellet form to an extruder which heats and directs the sheath material onto the cable or conductor core. The present invention includes the embodiment of incorporating the lubricating material into the sheath pellets during the formation of the sheath pellets and introducing this mixture of sheath pellets and lubricant material into an extruder, the embodiment of mixing the lubricant material with the sheath pellets and the embodiment of introducing this mixture into the extruder, and introducing the sheath pellets into the extruder and subsequently introducing the lubricating material into the extruder prior to contacting the cable core.

Advantageously, the lubricant material is selected from the group consisting essentially of fatty amides, hydrocarbon oils, and mixtures thereof. The lubricant material may be incorporated at any point in the manufacturing process before the formation of the sheath, and depending upon the material, may be heated prior to mixing with the sheath material.

In instances where the sheath material has a high melting or softening temperature, or for other reasons such as processibility, efficiency of the process, etc. the lubricant material may be added to the sheath material as the sheath material is being formed. If the final cable construction is such that there are two or more different sheath materials applied to the cable core, the lubricant material need only be incorporated into the outermost sheath material.

Advantageously, the lubricating materials include fatty amides, fatty acids, fatty esters and metallic fatty acids and more advantageously include fatty amides, fatty acids, fatty esters, and metallic fatty acids having from about 10 to about 28 carbon atoms preferably from about 10 to about 22 carbon atoms and include, but are not limited to erucamide, oleamide, oleyl palmitamide, stearyl stearamide, stearamide, behenamide, ethylene bisstearamide, ethylene bisoleamide, stearyl erucamide, erucyl stearamide, capric acid, lauric acid, myristic acid, palmitic acid, palmitoleic acid, stearic acid, oleic acid, vaccenic acid, linoleic acid, linolenic acid, eleostearic acid, arachidic acid, arachidonic acid, behenic acid, lignoceric acid, nervonic acid, cerotic acid, montanic acid, caprate, laurate, myristate, palmitate, palmitoleate, stearate, oleate, vaccinate, linoleate, linolenate, eleostearate, arachidate, arachidonate, behenate, lignocerate, nervonate, cerotate, montanate, pentaerythritol monopalmitate, pentaerythritol monostearate, pentaerythritol dipalmitate, pentaerythritol palmitate stearate, pentaerythritol distearate, and the like. Advantageous hydrocarbon oils include, but are not limited to, mineral oil, silicone oil, and the like. Lubricating materials suitable for the present invention further include plasticizers, dibasic esters, silicones, anti-static amines, organic amines, ethanolamides, mono-and di-glyceride fatty amines, ethoxylated fatty amines, fatty acids, zinc stearate, stearic acids, palmitic acids, calcium stearate, lead stearate, sulfates such as zinc sulfate, etc., and the like. The above lubricating materials may be used individually or in combination.

The electrical cable is characterized in that it incorporates a lubricating material in the sheath coating, which lubricating material blooms, migrates toward the exterior, or permeates the cable sheath. If desired the sheath material may be somewhat porous, thereby resulting in the lubricating material more readily migrating toward the exterior surface of the sheath.

The sheath of the cable thus contains sufficient lubricating material to provide an exterior surface with reduced coefficient of friction.

The equipment for the manufacturing of electrical cables is characterized in that it may include a device for the incorporation of a lubricating material into the sheath material prior to application to the cable core.

Said equipment may also include a tank to maintain the lubricating material, a section for mixing the lubricating material and sheath material and a section for applying the mixture to the cable core.

Moreover, the equipment may also include a pressure adjusting valve(s), a level indicator(s) of the lubricating material tank and sheath material tanks, and a pressure gauge(s).

### BRIEF DESCRIPTION OF THE DRAWINGS

For a better understanding of the present invention, a drawing is attached in which, schematically and by way of example, an embodiment is shown.

In said drawing,

FIG. 1 is a schematic elevation view of equipment for manufacturing electrical cable, according to the method of the present invention.

FIG. 2 is a section view of a THHN cable of the present invention.

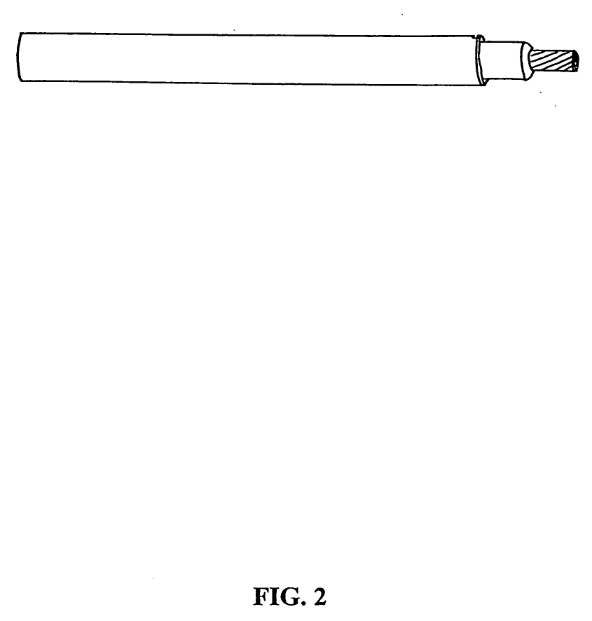

### DESCRIPTION OF A PREFERRED EMBODIMENT

THHN or THWN-2 conductors are 600 volt copper conductors with a thermoplastic insulation/nylon sheath and are heat, moisture, oil, and gasoline resistant. AWG sizes usually range from 14 through 6. THHN conductors are primarily used in conduit and cable trays for services, feeders, and branch circuits in commercial or industrial applications as specified in the National Electrical Code. Type THHN is suitable for use in dry locations at temperatures not to exceed 90° C. Type THWN-2 is suitable for use in wet or dry locations at temperatures not to exceed 90° C. or not to exceed 75° C. when exposed to oil or coolant. Type MTW is suitable for use in wet locations or when exposed to oil or coolant at temperatures not to exceed 60° C. or dry locations at temperatures not to exceed 90° C. Type THHN, THWN-2, and MTW copper conductors are usually annealed (soft) copper, insulated with a tough, heat and moisture resistant polyvinylchloride (PVC), over which a nylon (polyamide) or UL-listed equivalent jacket is applied.

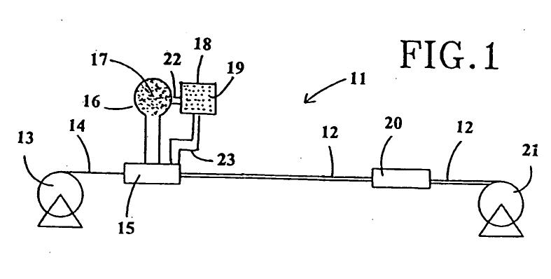

As can be appreciated in FIG. 1, the equipment 11 for manufacturing electrical cable 12 of the present invention includes a reel 13 which supplies conductor wire 14 to an extruding head 15, which in turn includes a tank 16 of second plastic material 17; a tank 18 of lubricating material 19 for mixture with plastic material 17 and for application onto the exterior surface of the conductor wire 14; a cooling box 20 for cooling the exterior surface of the plastic material 17—lubricating material 19 mixture which is in a state of fusion or semi-fusion on the conductor wire or cable core 14; and a reel 21 for taking up the resulting cable 12. Advantageously the conductor wire is coated with a first plastic material and this in turn is coated with the second plastic material-lubricating material mixture.

As can also be seen in the figures, the tank 18 may include a section 22 through which the lubricating material can pass into tank 16 and be mixed with second plastic material 17 and a section 23 through which lubricating material 19 can be introduced directly into extruding head 15 at a point after second plastic material 17 has been introduced into extruding head 15.

The plastic materials include known materials used in electrical wire and cable products such as polyethylene, polypropylene, polyvinylchloride, organic polymeric thermosetting and thermoplastic resins and elastomers, polyolefins, copolymers, vinyls, olefin-vinyl copolymers, polyamides, acrylics, polyesters, fluorocarbons, and the like. Advantageously the THHN cable of the present invention has a layer of polyvinylchloride insulation near or adjacent the conductor with an outer layer of polyamide, preferably nylon, or equivalent outer layer.

The present inventive method and the novel cable produced thereby includes the step of coating conductor wire or cable 14 with the mixture of second plastic material 17 and lubricating material 19 and optionally cooling the coated cable formed thereby.

Cable 12 is thus obtained with at least one conducting core and an exterior coating, the main characteristic of which is that its coefficient of friction is low, which makes it easier to install since it slips on the surfaces with which it comes into contact.

Another beneficial property gained by the present invention is an increased resistance to “burn-through.” “Burn-through,” or “pull-by,” results from friction generated by pulling one cable over another during installation, causing deterioration and eventual destruction to its own jacket as well as the jacket of the other cable. When using a lubricated cable of this invention the number of six-inch-stroke cycles required to produce burn-through was increased from 100 to 300.

The present inventive cable may also enhance ease in stripping the jacket from the cable end—termed stripability.

A further benefit of the present invention is the reduction of jacket rippling. Jacket rippling results from the friction of the jacket against building materials, causing the jacket material to stretch and bunch. Jacket damage may result. Installation situations, which repeatedly caused jacket rippling in unlubricated cable caused no rippling in lubricated cable jackets.

Despite the fact that reference has been made to specific embodiments of the invention, it will be clear to experts in the subject that the cable, the method and the equipment described can be varied and modified in many ways, and that all the details mentioned can be replaced by others which are technically equivalent without departing from the sphere of protection defined by the attached claims.

For example, cable 12 on which second plastic material 17 and lubricating material 19 are applied can be of any desired configuration and can be an optical fiber cable or the like.

It has been found experimentally that the use of a lubricating material disclosed herein is suitable for providing a considerable reduction of the coefficient of friction of the cable, which means that it is easier to install without adding any external element to it, which is one of the objectives sought in the present invention.

### EXAMPLE

To understand the affects of the jacket lubricant system on the ease of pull variations of the UL (Underwriters Laboratories, Inc.) joist pull test was utilized.

The joist pull test outlined in UL 719 Section 23 establishes the integrity of the outer PVC jacket of Type NM-B constructions when subjected to pulling through angled holes drilled through wood blocks.

The test apparatus consists of an arrangement of 2″×4″ wood blocks having holes drilled at 15° drilled through the broad face. Four of these blocks are then secured into an frame so that the centerlines of the holes are offset 10″ to create tension in the specimen through the blocks. A coil of NM-B is placed into a cold-box and is conditioned at −20° C. for 24 hours. A section of the cable is fed through corresponding holes in the blocks where the end protruding out of the last block is pulled through at 45° to the horizontal. The cable is then cut off and two other specimens are pulled through from the coil in the cold-box. Specimens that do not exhibit torn or broken jackets and maintain conductor spacing as set fort in the Standard are said to comply.

[image]

Pulling wire through the wood blocks provides a more direct correlation of the amount of force required to pull NM-B in during installation. Because of this relationship, the joist-pull test is initially the basis for which ease of pulling is measured, but a test for quantifying this “ease” into quantifiable data had to be established.

A variable-speed device was introduced to pull the cable specimen through the blocks. An electromechanical scale was installed between the specimen and the pulling device to provide a readout of the amount of force in the specimen. To create back tension a mass of known weight (5-lbs) was tied to the end of the specimen.

Data recorded proved that NM-B constructions having surface lubricates reduced pulling forces.

A 12-V constant speed winch having a steel cable and turning sheave was employed; the turning sheave maintains a 45 degree pulling angle and provides a half-speed to slow the rate of the pulling so that more data points could be obtained. Holes were drilled in rafters whereby specimens could be pulled by the winch.

It was found using this method that lubricated specimens yielded approximately a 50% reduction in pulling force when compared to standard, non-lubricated NM-B specimens. The results are shown in Tables 1 and 2 wherein the data was recorded at five second intervals.

[image]

TABLE 1

| | Specimen Description | | | | | | | | |
|---|---|---|---|---|---|---|---|---|---|
| | Manu- | Manu- | Manu- | Manu- | Manu- | Manu- | | | |
| Test Pt. | facturer | facturer | facturer | facturer | facturer | facturer | Control | Control | Present |
| Descr. | A1 | A2 | A3 | B1 | B2 | B3 | 1 | 2 | Invention |
| 1st Point | 26.8 | 48.3 | | 37.8 | 37.4 | | 16.5 | 41.9 | 24 |
| 2nd Point | 34.6 | 51.1 | | 35.2 | 38.1 | | 41.6 | 42 | 20.5 |
| 3rd Point | 33.7 | 46.8 | | 32 | 33 | | 40.2 | 38.7 | 20 |
| 4th Point | 38.6 | 49.8 | | 34.7 | 34.6 | | 41.3 | 29.5 | 17.4 |
| 5th Point | 33.1 | 44.8 | | 34.2 | 32.5 | | 41.3 | 34.3 | 20.2 |
| 6th Point | 28.6 | 44.7 | | 32.2 | 33.2 | | 42.5 | 35.9 | 15.8 |
| 7th Point | 5.5 | 51 | | 32.2 | 33.9 | | 41.1 | 37 | 17.2 |
| 8th Point | 26.8 | 49.2 | | 33.9 | 33 | | 40.9 | 38.4 | 17.3 |
| 9th Point | 21.9 | 52.5 | | 32.6 | 30.6 | | 42.7 | 37.3 | 21.9 |
| Average | 30.51 | 48.69 | | 33.87 | 34.03 | | 41.45 | 37.22 | 19.37 |

| | |
|---|---|
| AAA - | Denotes Outlyers |

Test in Table 1 performed at a constant speed with winch using ½ speed pulley
Test in Table 2 performed on cable with a 5# weight suspended at building entry

| Std. Prod. Average | Present Invention |
|---|---|
| 37.6289 | 19.37 |

TABLE 2

| | Specimen Description | | | | | | |
|---|---|---|---|---|---|---|---|
| Test Pt. | Manufacturer A | Manufacturer B | Control 1 | Control 2 | Control 3 | Invention A | Invention B |
| Descr. | 14-2 | 14-2 | 14-2/12-2 | 14-2/12-2 | 14-2/12-2 | 14-2/12-2 | 14-2/12-2 |
| 1st Point | 34 | 32.6 | 50 | 47.5 | 40.2 | 21.5 | 12.3 |
| 2nd Point | 35 | 35.7 | 50.6 | 38.3 | 37.5 | 22.9 | 12.8 |
| 3rd Point | 35.5 | 31.2 | 46.7 | 43.2 | 27.5 | 29 | 12.1 |
| 4th Point | 37.7 | 35 | 44.5 | 46 | 36.8 | 22.4 | 14.9 |
| 5th Point | 40.5 | 30.6 | 46.2 | 39.5 | 36 | 23.3 | 11.9 |
| 6th Point | 32.9 | 28.8 | 40.9 | 35.7 | 41.2 | 21.1 | 12.5 |
| 7th Point | 44.2 | 32.4 | 52.8 | 37.5 | 37 | 21.6 | 11.7 |
| 8th Point | 43 | 32.4 | 40.7 | 27.7 | 31.7 | 22.5 | 11.7 |
| 9th Point | 43.4 | 30.5 | 40 | 31.1 | | 19.2 | 11 |
| 10th Point | 40 | | | | | | 11.6 |
| Average | 38.62 | 32.13 | 45.82 | 38.50 | 35.99 | 22.61 | 12.25 |

| 14-2/12-2 | 14-2/12-2 | 14-2/12-2 |
|---|---|---|
| Control Avg. | Invention A | Invention B |
| 40.103241 | 22.61 | 12.25 |

TABLE 3
Pulling Data on THHN Cable

| Sample | Pulling Force, lbs |
|---|---|
| Control Cable | 38.5 |
| Cable + 0.25% additive A | 18.1 |
| Cable + 0.50% additive A | 16.0 |
| Cable + 0.85% additive A | 18.5 |
| Cable + 0.25% additive B | 13.2 |
| Cable + 0.50% additive B | 10.3 |
| Cable + 0.85% additive B | 9.6 |
| Cable + Yellow 77 lube | 15.3 |

[image]

1. A method for the manufacture of an electrical cable including:
providing an electrical conductor wire;
providing a first plastic material;
coating the conductor wire with the first plastic material;
providing a lubricating material;
providing a second plastic material;
mixing the second plastic material and said lubricating material; and
coating the first plastic coated conductor wire with said mixture of the second plastic material and lubricating material.

2. The method of claim 1, wherein the first and second plastic material are in the form of pellets.

3. The method of claim 2, wherein the first plastic material is polyvinylchloride.

4. The method of claim 2, wherein the second plastic material is a polyamide.

5. The method of claim 2, wherein the lubricating material is incorporated or mixed with the second plastic material prior to or as the second plastic material is formed into pellets.

6. The method of claim 1, wherein the lubricating material is introduced to and mixed with the second plastic material prior to coating the conductor wire.

7. The method of claim 1, wherein the step of coating the conductor wire is accomplished by extruding the mixture of the second plastic material and lubricating material onto the first plastic coated conductor wire.

8. The method of claim 7, wherein a mixture of the second plastic material and lubricating material is introduced into the extruder.

9. The method of claim 7, wherein the second plastic material is introduced into the extruder and the lubricating material is subsequently introduced into the extruder.

10. The method according to claim 1, wherein the lubricating material is selected from the group consisting essentially of fatty amides, fatty acids, fatty esters, metallic fatty acids, hydrocarbon oils, plasticizers, silicone oils and mixtures thereof.

11. An electrical cable including at least one conductor core coated with a plastic material without a lubrication material incorporated therein and at least one additional coating of plastic material having a lubricating material incorporated therein.

12. An apparatus for the manufacture of an electrical cable including a reel for supplying a conductor wire to an extruding head, said extruding head connected to a tank containing plastic material for coating the conducting wire, and a reel for taking up the cable, including a device for providing a lubricating material to the extruding head.

13. An apparatus for the manufacture of an electrical cable including a reel for supplying a conductor wire to an extruding head, said extruding head connected to a tank containing plastic material for coating the conducting wire, and a reel for taking up the cable, including a device for providing a lubricating material to the tank containing plastic material.

14. A method for manufacturing an electrical cable, comprising:
providing an electrical conductor wire;
providing a first plastic material;
coating the conductor wire with the first plastic material;
providing a lubricating material;
providing a second plastic material;
mixing the second plastic material and said lubricating material;
coating the first plastic coated conductor wire with said mixture of the second plastic material and lubricating material wherein the second plastic material has a temperature of at least 85° C.; and
cooling coated conductor wire.

15. The method of claim 14, wherein during the coating step, the second plastic material has a temperature of approximately 150 degree C.

16. The method of claim 14, wherein during the cooling step, the second plastic material and the lubricating material are cooled to approximately 20 degree. C.

17. The method of claim 14, wherein the lubricating material is selected from the group consisting of fatty amides, fatty acids, fatty esters, metallic fatty acids, hydrocarbon oils, plasticizers, silicone oils and mixtures thereof.

18. The method of claim 17, wherein the lubricating material comprises oleamide.

19. The method of claim 17, wherein the lubricating material comprises erucamide.

20. The method of claim 17, wherein the lubricating material comprises mineral oil.

21. The method of claim 17, wherein the lubricating material comprises silicone oil.

22. The method of claim 17, wherein the lubricating material comprises dibasic esters.

23. The method of claim 17, wherein the lubricating material comprises ethylenebisstearamide.

24. A material for reducing the friction between the outer surface of a cable and a structure which the cable contacts selected from the group consisting of fatty amides, fatty acids, fatty esters, metallic fatty acids, and mixtures thereof.

25. A composition of matter comprising a lubricating material mixed with a plastic material, said lubricating material selected from the group consisting of fatty amides, fatty acids, fatty esters, metallic fatty acids, and mixtures thereof.

26. An electrical cable comprising an electrical conductor wire coated with a first plastic material without a lubricating material incorporated therein, said first plastic coated conductor wire coated with a mixture of a second plastic material and lubricating material.

27. The electrical cable of claim 26, wherein the first plastic material is a polyvinylchloride.

28. The electrical cable of claim 26, wherein the second plastic material is a polyamide.

29. The electrical cable of claim 26, wherein the lubricating material is selected from the group consisting essentially of fatty amides, fatty acids, fatty esters, metallic fatty acids, hydrocarbon oils, plasticizers, silicone oils and mixtures thereof.

30. The electrical cable of claim 27, wherein the lubricating material comprises oleamide.

31. The electrical cable of claim 27, wherein the lubricating material comprises erucamide.

32. The electrical cable of claim 27, wherein the lubricating material comprises mineral oil.

33. The electrical cable of claim 27, wherein the lubricating material comprises silicone oil.

34. The electrical cable of claim 27, wherein the lubricating material comprises dibasic esters.

35. The electrical cable of claim 27, wherein the lubricating material comprises ethylenebisstearamide.

36. The electrical cable of claim 26, wherein the lubricating material is incorporated or mixed with the second plastic material prior to or as the second plastic material is formed into pellets.

37. The electrical cable of claim 26, wherein the lubricating material is introduced to and mixed with the second plastic material prior to coating the conductor wire.

38. The electrical cable of claim 26, wherein the mixture of the second plastic material and lubricating material is extruded onto the first plastic coated conductor wire.
